(19) United States
(12) Patent Application Publication
(10) Pub. No.: US 2019/0061612 A1
(43) Pub. Date: Feb. 28, 2019

(54) LIGHT BAR ASSEMBLY FOR AUTOMOBILES

(71) Applicants: ROBERT L. Hart, CINCINNATI, OH (US); KAREN SCHMAHL, FAIRFIELD, OH (US)

(72) Inventors: ROBERT L. Hart, CINCINNATI, OH (US); KAREN SCHMAHL, FAIRFIELD, OH (US)

(21) Appl. No.: 16/045,698

(22) Filed: Jul. 25, 2018

Related U.S. Application Data
(60) Provisional application No. 62/553,012, filed on Aug. 31, 2017.

(51) Int. Cl. B60Q 1/52; B60Q 1/00; B60Q 1/38

(52) U.S. Cl. CPC B60Q 1/52; B60Q 1/2619; B60Q 1/38; B60Q 1/0041

(57) ABSTRACT

The present invention discloses a light bar for an automobile. The light bar comprises a housing, configured to hold a plurality of light enclosure units. The light enclosure units embedded with a plurality of light emitting sources for providing a clear path for emission of light from the light emitting sources. The light bar is positioned on the bottom rear-end of the chassis and wing mirror of the automobile, via one or more fastening means. The light bar further comprises a controller, disposed within the housing. The controller is configured to control the light emitting sources to emit at least one of a single or a multi-colored light signal for providing visual indications to the trailing drivers.

### BACKGROUND OF THE INVENTION

### A. Technical Field

The present invention generally relates to a light bar or light bar assembly for an automobile. Specifically, the present invention relates to a light bar for automobiles, positioned on exterior of the automobile with multiple light emitting sources, configured to emit multiple colors of light providing visual indications to the trailing drivers.

### B. Description of Related Art

Generally, light assemblies are used as an indication system in vehicles such as ambulances, fire trucks and law enforcement vehicles. Traditionally, light assemblies are mounted to the exterior roof or side of the automobile. The light assembly, however, possesses certain inherent disadvantages. Firstly, light assemblies increase vehicle wind resistance and thus increase fuel consumption. Also, because of the turbulence created thereby, conventional light assemblies will cause at least some increase in the ambient noise level and will thus have a negative effect on communications. Further, light assemblies will increase vehicle height and this, in turn, may limit access to certain areas and present the possibility of damage to the light assemblies in situations where there is reduced overhead clearance.

Currently, known light assemblies are mostly not suitable to all classes of new automobiles. This is a practical problem because the desired arrangement of components varies from vehicle to vehicle in a particular jurisdiction. A resultant complication and expense is, thus, introduced into the process of manufacturing light assemblies, since bases must be custom punched for each desired component arrangement.

Accordingly, there is a need for light assemblies for use in all classes of new automobiles, SUV's, trucks, van and heavy vehicles or the like that is capable of displaying multiple colors and patterns corresponding to different emergency and directional signals. The light assemblies should be capable of producing a multiple color and pattern emergency and directional signals. The light assemblies should include a plurality of LED packages aligned in multiple rows wherein each individual diode is capable of changing color. As a result, the light assemblies can be made smaller and more efficient in terms of cost and complexity to manufacture without losing any light output strength.

### SUMMARY OF THE INVENTION

The present invention generally discloses a light bar or light bar assembly for an automobile. The present invention directed to a light bar for an automobile, positioned on exterior of the automobile including multiple light emitting sources, configured to emit multiple colors of light to give visual indications of their presence during emergencies and while changing directions or making a turn.

In an embodiment, the light bar assembly comprises a housing, which is configured to adapt to the shape of a support surface of the automobile to which the light bar assembly is installed. The housing holding a plurality of light enclosure units. A plurality of light emitting sources embedded within the plurality of light enclosure units by providing a clear path for emission of light from the light emitting source. The light bar is positioned on the bottom rear-end of the chassis of the automobile within four feet from the ground clearance of the automobile, via one or more fastening means. In one embodiment, the light bar is disposed on particular side, but not limited to, the rear side of the automobile. The light bar assembly further comprises a controller, disposed within the housing of the light bar. The controller is configured to control the light emitting sources to emit at least one of a single or a multi-colored light signal. In one embodiment, the light emitting source is a Light Emitting Diode (LED).

In one embodiment, the light bar is positioned on the wing mirror of the automobile, via one or more fastening means. In one embodiment, the light bar is disposed on the rear side housing of the wing mirror assembly. The light bar assembly is retrofittably attached to the housing of the wing mirror assembly by adhesives or any other fastening mechanism. The light bar assembly and the wing mirror housing may have mating surface configurations, which at least partially retain the light bar assembly in the housing.

In one embodiment, the plurality of light enclosure units comprises a plurality of light emitting sources in multiple rows. The plurality of light emitting sources are configured to emit single and multiple colors of light to indicate the emergency and directional signals such as brake position or braking rate, turn signal position, emergency, and back-up for the automobile.

In one embodiment, the light emitting sources are connected in series with the controller or a power unit. In another embodiment, the light emitting sources are connected in parallel with the controller or a power unit. In some embodiments, the light emitting sources are embedded to the light enclosure units by adhesives or any other fastening mechanism. In another embodiment, printed circuit boards (PCB) for all devices are fabricated in accordance to the final assembler's requirements. Standard thickness, double sided FR4 circuit board material is populated with surface mounted components where possible.

In one embodiment, the light bar is designed to retrofit on the exterior surface of the existing automobiles. In another embodiment, the light bar is integrated to the exterior surface of the automobiles. In one embodiment, the light bar assembly further comprises a power module. In one embodiment, the power module could be connected to the switched power source using appropriate circuit protection. In one embodiment, the power module and hardware of the light bar is connected to the electrical system of the automobile.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 shows a perspective view of a vehicle installed with a light bar assembly in one embodiment of the present invention.

FIG. 2 shows a front view of the light bar assembly in an embodiment of the present invention.

FIG. 3 shows a rear view of a wing mirror installed with a light bar assembly in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

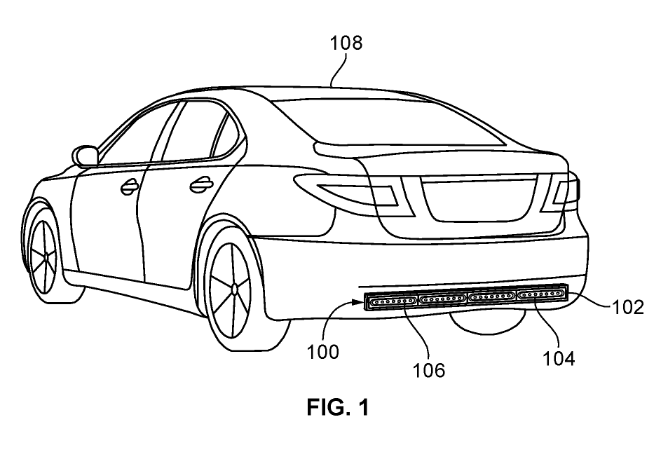

Referring to FIG. 1, the perspective view of a vehicle installed with a light bar assembly 100 is illustrated. In an embodiment, the light bar assembly or light bar 100 comprises a housing 102, which is adapted to the shape of a support surface in the automobile or vehicle 108. In one embodiment, the housing 102 configured to hold a plurality of light enclosure units 104. The light enclosure unit 104 embedded with a plurality of light emitting sources 106 for providing a clear path for emission of light from the light emitting source 106. In some embodiments, the light bar 100 is positioned on the bottom rear-end of the chassis of the automobile 108. The light bar could be assembled within four feet from the ground clearance of the automobile, via one or more fastening means.

In one embodiment, the light bar 100 is disposed on particular side, but not limited to, the rear side of the automobile 108. The light bar assembly 100 further comprises a controller, disposed within the housing 102 of the light bar 100. The controller is configured to control the light emitting sources 106 to emit at least one of a single or a multi-colored light signal. In one embodiment, the light emitting source 106 is a Light Emitting Diode (LED).

In one embodiment, the light bar 100 further comprises one or more LED protection resistor. In one embodiment, the leads of the plurality of light emitting sources 106 are connected in series or parallel circuit to the LED protection resistor. Further, the LED protecting resistor connected to the controller of the light bar 100. The controller is connected with each of the plurality of light emitting sources 106.

In one embodiment, the light emitting sources 106 are embedded to the light enclosure units 104 by adhesives or any other fastening mechanism. In another embodiment, printed circuit boards (PCB) for all devices are fabricated in accordance to the final assembler's requirements. Standard thickness, double sided FR4 circuit board material is populated with surface mounted components where possible. In one embodiment, the light emitting sources 106 are connected in series with the controller of the light bar 100. In another embodiment, the light emitting sources 106 are connected in parallel with the controller of the light bar 100.

In one embodiment, the light bar 100 is retrofittably attached to the exterior surface of the automobile 108. In another embodiment, the light bar 100 is integrated to the exterior surface of the automobile 108.

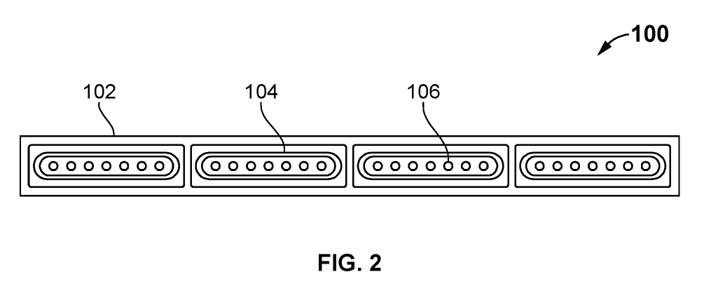

Referring to FIG. 2, the front view of the light bar assembly 100 is illustrated. The light bar housing 102 comprises a high-powered light emitting sources or LEDs 106 recessed within the light enclosure units 104 that could provide long range sight to a trailing automobile driver. In one embodiment, the plurality of light emitting sources 106 are configured to emit single and multiple colours of light to represent the emergency and directional signals such as brake position or braking rate, turn signal position, emergency and back-up for the automobile 108.

In one embodiment, the light emitting sources 106 are configured to emit single coloured light to represent the emergency and directional signals for the automobile 108. In another embodiment, the light emitting sources 106 are configured to emit multiple coloured light to indicate the emergency and directional signals for the automobile 108. In some embodiments, the light emitting sources 106 are brightened in a red color to represent the braking position of the automobile and it is visible to the trailing automobile drivers.

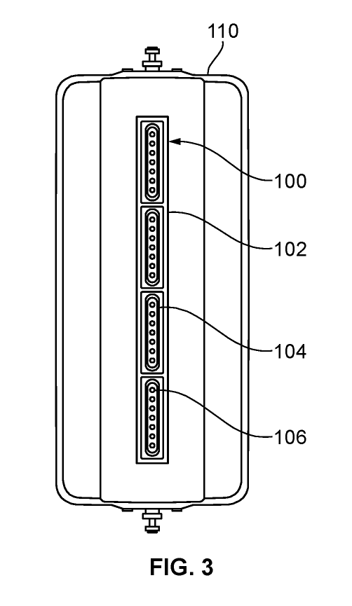

Referring to FIG. 3, the rear view of a wing mirror installed with a light bar assembly 100 is illustrated. In one embodiment, the light bar 100 is retrofittably attached to the rear side of the wing mirror assembly 110 by adhesives or any other fastening mechanism. The wing mirror assembly 110 is adapted for mounting to a side of the automobile 108. The wing mirror assembly 110 is equipped for manual or remote vertical and horizontal adjustment so as to provide adequate coverage to drivers of differing height and seated position.

In another embodiment, the light bar 100 is disposed on the rear side housing of the wing mirror assembly 110. The light bar assembly 100 is retrofittably attached to the housing of the wing mirror assembly 110 by adhesives or any other fastening mechanism. The light bar assembly 100 and the wing mirror housing may have mating surface configurations, which at least partially retain the light bar assembly 100 in the housing. This may eliminate the requirement for multiple fasteners which must be removed in order to service the light bar assembly 100.

The light bar assembly 100 in the wing mirror assembly 110 is configured to emit at least one of a single or a multi-colored light to indicate the emergency and directional signals such as brake position or braking rate, turn signal position, emergency, and back-up for the automobile, visible from the side of the equipped vehicle.

In one embodiment, the light bar assembly 100 further comprises a power module. In one embodiment, the power module could be connected to the switched power source using appropriate circuit protection. In one embodiment, the power module and hardware of the light bar 100 is connected to the electrical system of the automobile 108. In one embodiment, the automobile 108 comprises a steering wheel, which is equipped with a switch to control the operation of the light emitting sources 106 of the light bar 100 by a user. In another embodiment, the rear side of the housing 102 of the light bar 100 comprises a switch to control the operation of the light emitting sources 106 of the light bar 100 in the automobile 108 by the user.

In one embodiment, a desired color of LED could be chosen based on the applications. In one embodiment, the housing 102 could also be dimensioned to various shape based on the applications. In one embodiment, the housing 102 of the light bar 100 could be molded to any height or width with 1-5 centimeters depth. The depth of the housing 102 of the light bar 100 is chosen depending upon the number of LEDs used. In one embodiment, the housing 102 of the light bar 100 is in rectangular shape.

The light bar 100 is a multifunctional apparatus to indicate the emergency and directional signals for the automobile 108. The light bar 100 is used in all classes of new automobiles, SUV's, trucks, van and heavy vehicles or the like that is capable of displaying multiple colors and patterns corresponding to different emergency and directional signals. The light bar 100 is easily visible to the trailing vehicle driver, thereby avoids accidents and ensure safety to the user. The light bar 100 is retrofittably attached to the housing on the exterior surface and wing mirrors of the automobiles.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A light bar for an automobile, comprising:
a housing holding a plurality of light enclosure units, wherein said light enclosure units includes a plurality of light emitting sources, and
a controller connected to each of the plurality of light emitting sources,
wherein said light bar is positioned on the bottom rear-end of the chassis of the automobile, via one or more fastening means.

2. The light bar of claim 1, is positioned on the bottom rear-end of the chassis within four feet from the ground clearance of the automobile.

3. The light bar of claim 1, is positioned on the wing mirror of the automobile, via one or more fastening means.

4. The light bar of claim 1, wherein the plurality of light enclosure units comprises a plurality of light emitting sources in multiple rows.

5. The light bar of claim 1, wherein the plurality of light emitting sources are configured to emit single and multiple colors of light.

6. The light bar of claim 1, wherein the controller is configured to control the light emitting sources to emit at least one of a single colored light signal and at least one of multi-colored light signals to indicate emergency and directional signals for the trailing automobiles.

7. The light bar of claim 1, wherein the light emitting sources are connected in series to the controller.

8. The light bar of claim 1, wherein the light emitting sources are connected in parallel to the controller.

9. The light bar of claim 1, is integrated to the exterior surface of the automobiles.

10. The light bar of claim 1, is retrofittably attached to the existing automobiles.
